(19) United States
(12) Patent Application Publication
(10) Pub. No.: US 2017/0268641 A1
(43) Pub. Date: Sep. 21, 2017

(54) BALL BEARING RELIEF FOR MULTIPLE TURN CIRCUIT IN BALL SCREW ASSEMBLY

(71) Applicant: Dynatect Manufacturing, Inc., New Berlin, WI (US)

(72) Inventors: Thomas R. Burpee, Traverse City, MI (US); Scott Smith, Interlochen, MI (US)

(73) Assignee: Dynatect Manufacturing, Inc., New Berlin, WI (US)

(21) Appl. No.: 15/461,132

(22) Filed: Mar. 16, 2017

Related U.S. Application Data
(60) Provisional application No. 62/309,278, filed on Mar. 16, 2016.

(51) Int. Cl. F16H 25/22

(52) U.S. Cl. CPC F16H 25/2214

(57) ABSTRACT

A ball relief feature for a ball screw allows multiple turn ball circuits with reduced ball bearing stack-up within the ball screw assembly. Reliving bearing stack up allows for ball circuits having more turns without reducing the number of load carrying ball bearings of a typical ball nut. The ball relief feature reduces ball bearing stack-up by allowing the balls to re-distribute relative to one another and space themselves evenly in oversized portions of the ball circuit track other than the ball return mechanism.

### CROSS-REFERENCE TO RELATED APPLICATION

This application is based on and claims priority to U.S. Provisional Patent Application No. 62/309,278 filed on Mar. 16, 2016, which is incorporated herein by reference in its entirety for all purposes.

### FIELD OF THE INVENTION

The present invention relates generally to the field of ball screws. More particularly, the present invention relates to a ball nut that includes a relief portion to prevent stack-up of ball bearings traveling through multiple turn ball circuits.

### BACKGROUND

A ball screw is a mechanical device that translates rotational motion into linear motion. Typical ball screws include a leadscrew portion that is threaded to include at least one raceway through which a series of ball bearings travel. Each raceway has a pitch, which is defined as the axial distance between threads and is typically measured in threads per inch or millimeter. Leadscrews may have one raceway, or may alternatively include multiple raceways that follow alongside each other. The balls are captured inside a ball nut that includes its own raceways that correspond to the raceways of the leadscrew.

The above mentioned raceways combine to form a circuit through which the ball bearings travel. To complete the circuit, the ball nuts include a mechanism for removing the ball bearings from one end of the circuit and transferring them to the other end of the circuit. A circuit can comprise anywhere from one to several complete turns around the screw before the balls are re-directed back to the beginning of the circuit. A ball screw and nut assembly may comprise anywhere from one to several circuits.

Currently the number of turns that can comprise a circuit is limited by a phenomenon known as ball stack up in which the ball bearings may jam or bind against one another as they roll through the ball track formed by the screw and nut with different amounts of slippage. If nothing is done to prevent ball stack up, the maximum number of turns that comprise a circuit is typically between 5 and 10 turns, depending on a number of factors. One common method of dealing with this problem is incorporating spacer balls amongst the load carrying balls. The spacer balls are smaller in diameter than the loading carrying balls, allowing the load carrying balls to slip more readily and preventing the load carrying balls from binding against one another. The problem with using spacer balls is that they significantly reduce the load carrying capacity of the ball screw assembly, because the load is being carried by fewer balls.

It is also desirable to produce a ball screw assembly having as few circuits and as many turns per circuit as possible for several reasons. First, each circuit requires its own ball return mechanism; therefore, limiting the number of ball returns reduces the cost to manufacture the ball screw. In addition, there must also be some amount of space between each circuit. This space is essentially wasted space, as there can be no load carrying balls within that unused space.

Finally, typical ball screws having internal ball return systems must be installed on a ball screw at an end of the screw because that is the only position where the raceway is accessible such that ball bearings loaded into the ball nut may be installed on the leadscrew. However, in some applications, the leadscrew raceway may not extend all the way to both ends of the leadscrew, making it impossible to install a ball nut having an internal ball return system.

Hence there is a need for a ball nut assembly that prevents ball bearing stack-up while also increasing the number of turns that a given circuit can handle. In addition, there is a need for a ball nut assembly having an internal ball return system that may be installed on a leadscrew away from either end of the leadscrew.

### SUMMARY

The present invention relates to a ball screw assembly that includes a leadscrew having at least one leadscrew raceway. A ball nut having a body capable of surrounding the leadscrew includes an internal raceway capable of aligning with the leadscrew raceway. A plurality of ball bearings are captured between the internal raceway and the leadscrew channel. The internal raceway further includes an oversized portion that allows the ball bearings to re-distribute relative to one another as they pass through the oversized portion.

The present invention further relates to a method of installing a ball nut onto a leadscrew having at least one leadscrew raceway that does not extend to an end of the leadscrew. The method includes providing a ball nut having a body and at least one internal raceway corresponding to the at least one leadscrew raceway, where the ball nut further includes at least one cut-out portion on the body that allows access to the leadscrew raceway through the body. Next, a user moves the ball nut over the leadscrew until the cut-out portion aligns with the leadscrew raceway. Next, the user inserts ball bearings through the cut-out portion until the raceway is filled with ball bearings. Finally, after the raceway is filled, the user installs an insert having an oversized ball track into the cut-out and secures the insert into the cut-out.

It will be understood by those skilled in the art that one or more aspects of this invention can meet certain objectives, while one or more other aspects can lead to certain other objectives. Other objects, features, benefits and advantages of the present invention will be apparent in this summary and descriptions of the disclosed embodiment, and will be readily apparent to those skilled in the art. Such objects, features, benefits and advantages will be apparent from the above as taken in conjunction with the accompanying figures and all reasonable inferences to be drawn therefrom.

### BRIEF DESCRIPTION OF THE DRAWINGS

FIG. 1 is a perspective view of a leadscrew and ball nut including one embodiment of a ball bearing relief in accordance with the invention;

FIG. 1A is a top view of the leadscrew and ball nut of FIG. 1;

FIG. 2 is an exploded perspective view of the ball nut shown in FIG. 1;

FIG. 3 is a section view of the leadscrew and ball nut of FIG. 1 taken generally along the line 3-3 in FIG. 1A;

FIG. 4 is a section view of the ball nut of FIG. 1 taken generally along the line 4-4 in FIG. 3; and

FIG. 5 is a perspective view of the section view of FIG. 4 showing the path of ball bearings through the ball nut of FIG. 1.

### DETAILED DESCRIPTION

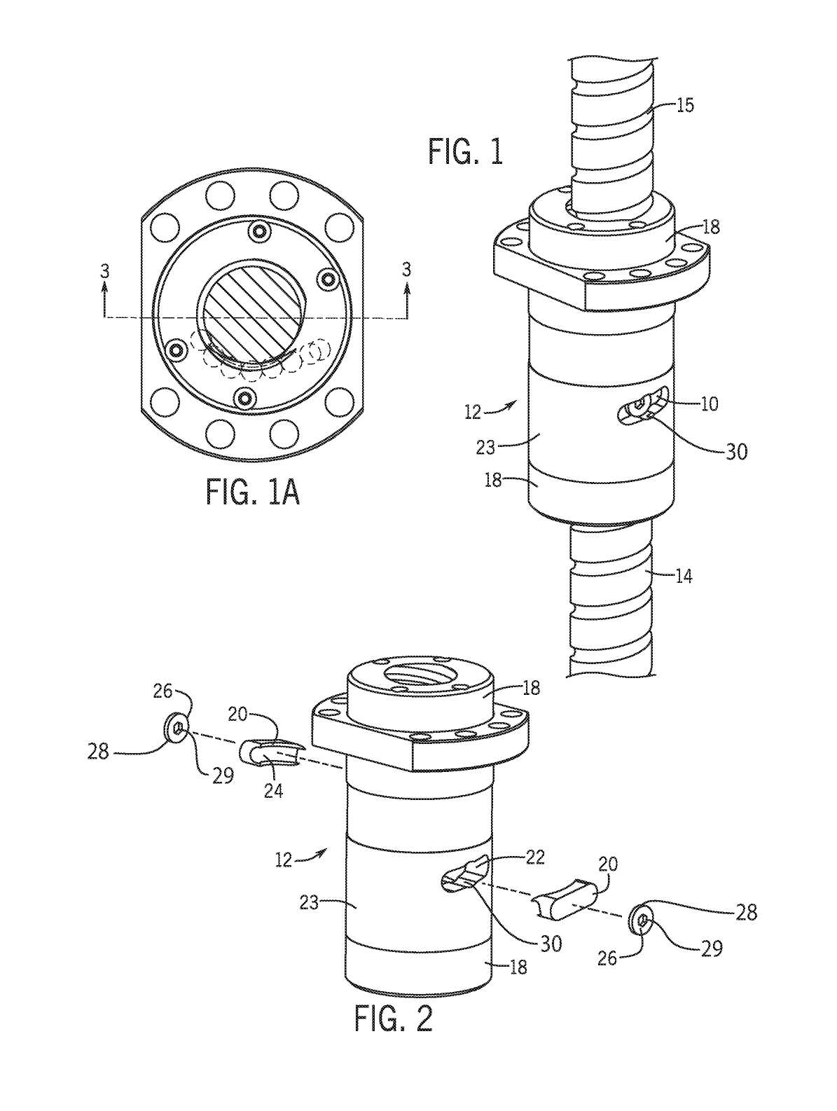

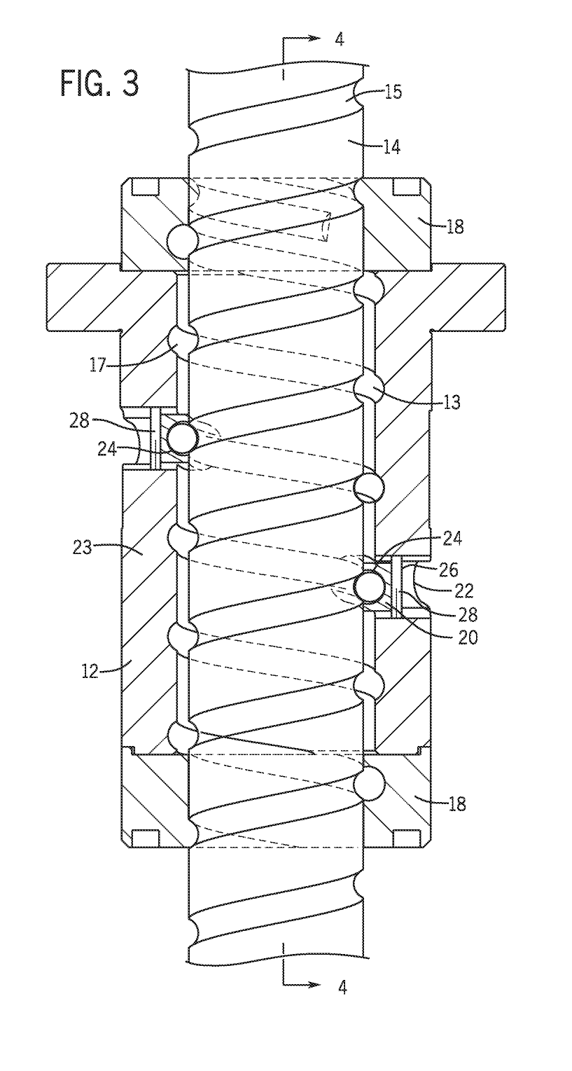

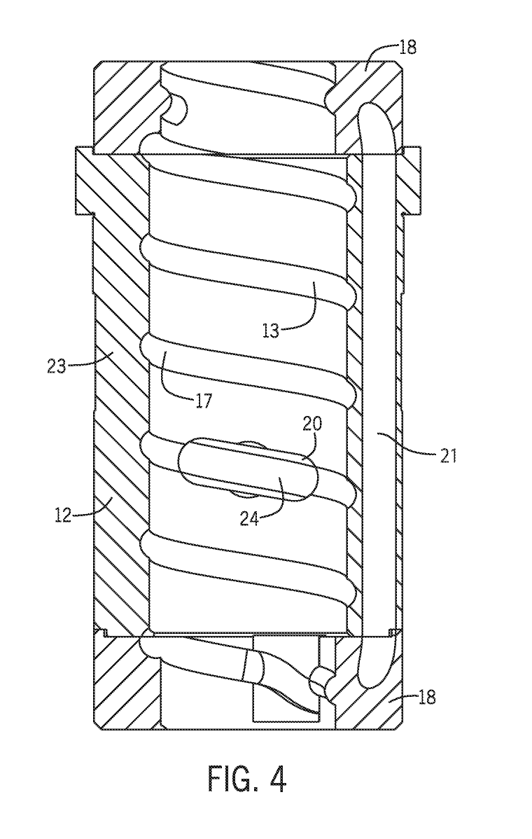

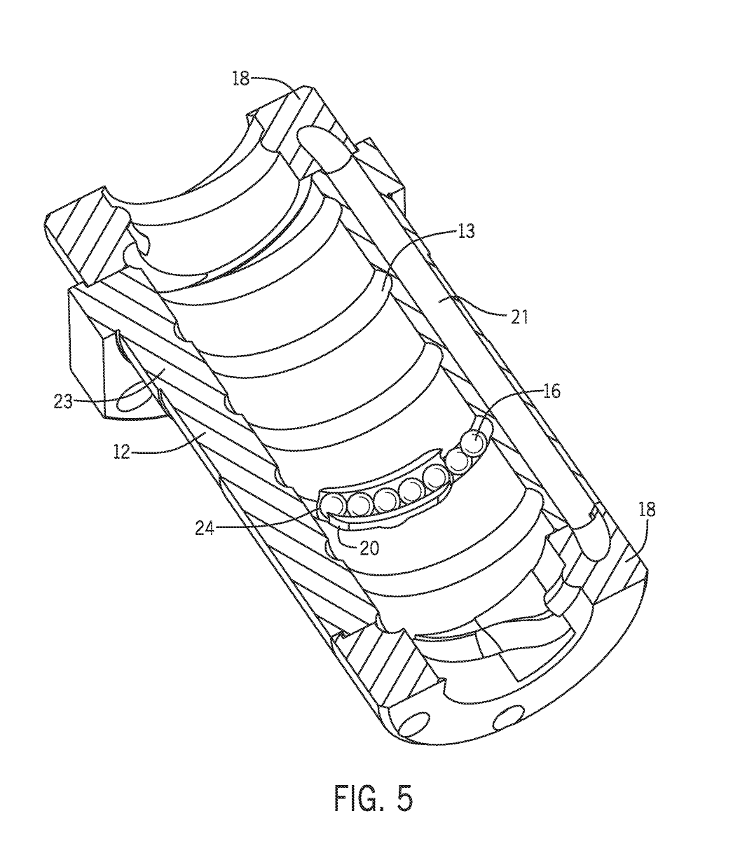

As shown in FIGS. 1-5, the present invention relates to a ball nut 12 for installation on a leadscrew 14. Ball nut 12 further includes a ball track 13 that corresponds to a raceway 15 on leadscrew 14 and forming a circuit 17 within the ball nut through which the ball bearings, or balls, 16 circulate. The invention provides a relief feature 10 in the ball nut 12, so as to allow balls 16 traveling through the ball nut to re-distribute relative to one another at a point in circuit 17 other than a ball return mechanism 18. The ball return mechanism 18 shown in the present embodiment includes an end cap 19 that lifts the balls 16 out of raceway 15 and redirects them back through the ball nut via longitudinal tube 21. Rotating leadscrew 14 moves the balls 16 along the raceways 15 and through circuit 17, thereby causing ball nut 12 to move longitudinally along the leadscrew.

In the embodiment shown, relief feature 10 includes an insert 20 that is inserted into a cut-out 22 in the wall 23 of ball nut 12. Insert 20 may be made of plastic (or any other suitable material) and includes a section of oversize ball track 24. In the embodiment shown, insert 20 is slightly undersized compared to cut-out 22, which allows the insert to float slightly within the cut-out. Insert 20 is retained in the cut-out 22 by a threaded fastener 26. In the embodiment shown, threaded fastener 26 has a thickness and includes threads 28 around the exterior of the fastener. The threads 28 engage with a threaded portion 30 of cut-out 22. Fastener 26 also includes a faceted inside opening 29 for wrenching, such as a six-sided opening shown for use with a wrench such as an Allen wrench. In some embodiments, adhesive or other material such as epoxy resin may be used to further secure insert 20 in cut-out 22, although the use of such additional material is not always necessary. Alternatively, relief feature 10 may be formed by machining a portion of oversized ball track integral to the ball nut 12 itself

As shown in FIGS. 3-5, relief feature 10 allows the ball bearings 16 to slide freely relative to one another as they pass through oversize ball track 24 before being tightly clamped between the ball tracks 13, 15 of the screw and nut once again. In the embodiment shown, oversize ball track 24 is approximately 0.001″ larger than ball track 13, but any suitable amount, such as the next larger drill size from the nominal ball size, may alternatively be used without departing from the invention. It is important not to made the oversize ball track 24 too large, however. The oversize ball track 24 should be just large enough so that the balls 16 are not under load as they pass through the oversize section. Making the oversize ball track 24 too much larger than ball track 13 may create a step in the track, which can affect how smoothly balls circulate through the ball nut 12.

Allowing the balls 16 to slide freely relative to one another as they pass through the relief feature 10 effectively relieves any pressure or binding that may have developed as the balls roll, tightly clamped, between the leadscrew 14 and ball nut 12 for the portion of the circuit 17 upstream of the relief feature. Thus, the balls 16 are able to re-distribute and space themselves evenly again as they pass through the relief feature 10 before entering the downstream part of circuit 17.

Although the relief feature 10 is shown here as an oversize ball track 24, the ball relief can alternatively be accomplished through any suitable method of providing a portion of ball track 13 that releases the balls 16 from the normally heavy clamping pressure between leadscrew 14 and ball nut 12.

The multiple turn circuit ball relief is best employed with the use of end cap returns 18 to create a single circuit that runs the entire length of the ball nut 12. One or more ball relief features 10 may be employed to prevent stack-up of the balls 16 throughout the circuit. The ball relief feature 10 could potentially be used with other return mechanisms but is most advantageous with end cap returns because end cap returns are typically used in internal ball return nuts, which do not provide access to the balls or the raceway from the outside of the nut.

In addition to the benefit of providing relief to the balls 16 as they circulate through the ball nut 12, insert 20 also allows for installation of ball nut 12 having end cap returns on a leadscrew having a raceway 15 that does not extend to either end of the leadscrew. Typical leadscrews with internal ball return systems are installed at the end of the leadscrew and require the use of a loading arbor or other additional part to prevent balls 16 from falling out of the ball nut 12 during installation. The need for the loading arbor or other additional part is eliminated by using the relief feature 10 of the present invention to assemble the ball nut 12 in a position away from the ends of the leadscrew 14. To assemble the ball nut 12, a user moves the ball nut over the leadscrew 14 without the ball bearings 16 installed. Once the ball nut 12 is in position over the raceway 15, a user can insert the ball bearings 16 through cut-out 22. After the balls 16 have been inserted into the ball nut 12, the user installs insert 20 by placing it in cut-out 22 and securing it using threaded fastener 26.

Although the invention has been herein described in what is perceived to be the most practical and preferred embodiments, it is to be understood that the invention is not intended to be limited to the specific embodiments set forth above. Rather, it is recognized that modifications may be made by one of skill in the art of the invention without departing from the spirit or intent of the invention and, therefore, the invention is to be taken as including all reasonable equivalents to the subject matter of the appended claims and the description of the invention herein.

What is claimed is:

1. A ball screw assembly comprising:
a leadscrew having at least one leadscrew raceway;
a ball nut having a body that surrounds the leadscrew;
the ball nut having an internal raceway that aligns with the leadscrew raceway;
a plurality of ball bearings captured between the internal raceway and the leadscrew raceway; and
the internal raceway further including an oversized portion that allows the ball bearings to re-distribute relative to one another as they pass through the oversized portion.

2. The ball screw assembly of claim 1, wherein the oversized portion is integrally formed in the ball nut.

3. The ball screw assembly of claim 1, wherein the oversized portion is included on an insert that is installed through a cut-out on the ball nut.

4. The ball screw assembly of claim 3, wherein the insert is secured to the ball nut by a threaded fastener.

5. The ball screw assembly of claim 3, wherein the insert is secured to the ball nut by adhesive.

6. The ball screw assembly of claim 3, wherein the insert is made of plastic.

7. The ball screw assembly of claim 4, wherein the insert is further secured to the ball nut by epoxy resin.

8. The ball screw assembly of claim 4, wherein the insert is further secured to the ball nut by adhesive.

9. A method for installing a ball nut onto a leadscrew having at least one leadscrew raceway that does not extend to an end of the leadscrew, the method including the steps of:
providing a ball nut having a body and at least one internal raceway corresponding to the at least one leadscrew raceway, the ball nut further including at least one cut-out portion on the body that allows access to the leadscrew raceway through the body;
moving the ball nut over the leadscrew;
aligning the cut-out portion with the leadscrew raceway;
inserting a plurality of ball bearings through the cut-out portion; and
installing an insert having an oversized ball track into the cut-out; and
securing the insert into the cut-out.

10. A method for installing a ball nut onto a leadscrew having at least one leadscrew raceway that does not extend to an end of the leadscrew, the ball nut having a body and at least one internal raceway corresponding to the at least one leadscrew raceway, the ball nut further including at least one cut-out portion on the body that allows access to the leadscrew raceway through the body, the method including the steps of:
moving the ball nut over the leadscrew;
aligning the cut-out portion with the leadscrew raceway;
inserting a plurality of ball bearings through the cut-out portion; and
closing the cut-out portion.

11. The method of claim 10 wherein the step of closing the cut-out portion includes installing an insert having an oversized ball track into the cut-out.

12. The method of claim 11 further comprising securing the insert into the cut-out.

13. The method of claim 12 further comprising using a threaded fastener to secure the insert into the cut-out.

14. The method of claim 13 further comprising using one of an epoxy resin and an adhesive to further secure the insert into the cut-out.

15. A ball screw assembly comprising:
a leadscrew having at least one leadscrew raceway;
a ball nut having a body that surrounds the leadscrew, the body having an internal raceway capable of being aligned with the leadscrew raceway, and when so aligned, the leadscrew raceway and internal raceway coact to form a circuit; and
the internal raceway further including an oversized portion, sized so as to allow ball bearings to slide freely relative to each other as they pass through the oversized portion.

16. The ball screw assembly of claim 15, wherein the oversized portion is integrally formed in the ball nut.

17. The ball screw assembly of claim 15, wherein the oversized portion is included on an insert that is installed through a cut-out on the ball nut.

18. The ball screw assembly of claim 15, wherein a plurality of ball bearings are captured inside the circuit, the circuit having an inside diameter over most of its length that is substantially the same as the diameter of the ball bearings.

19. The ball screw assembly of claim 17, wherein the insert is secured to the ball nut by a threaded fastener.

20. The ball screw assembly of claim 17, wherein the insert is secured to the ball nut by adhesive.

21. The ball screw assembly of claim 17, wherein the insert is made of plastic.

22. The ball screw assembly of claim 18, wherein the insert is further secured to the ball nut by epoxy resin.

23. The ball screw assembly of claim 18, wherein the insert is further secured to the ball nut by adhesive.
